(19) United States
(12) Patent Application Publication
(10) Pub. No.: US 2023/0306429 A1
(43) Pub. Date: Sep. 28, 2023

(54) METHOD FOR MAINTAINING ETHICAL ARTIFICIAL INTELLIGENCE (AI)

(71) Applicant: Actimize LTD., Ra'anana (IL)

(72) Inventors: Amir SHACHAR, Haifa (IL); Danny BUTVINIK, Haifa (IL); Yoav AVNEON, Ness-Zyiona (IL)

(21) Appl. No.: 17/701,723

(22) Filed: Mar. 23, 2022

(51) Int. Cl. G06Q 20/40; G06N 20/20

(52) U.S. Cl. CPC G06Q 20/4016; G06N 20/20

(57) ABSTRACT

A computerized-method for maintaining ethical Artificial-Intelligence by generating a representative-training-sample-dataset for a fraud-detection Machine-Learning (ML) model, by: (i) operating a representative-dataset-preparation module to generate a representative-training-sample-dataset by operating balanced-sampling on randomly-selected preconfigured-number of financial-transactions. The balanced-sampling may be operated by applying a configurable-rule on at least two values of a parameter of non-sensitive PII parameters of each financial-transaction by a low-frequency value; (ii) training the fraud-detection ML model on the representative-training-sample-dataset; and (iii) deploying the trained fraud-detection ML model in a finance-system in test-environment, and operating the trained fraud-detection ML model on a stream-of-financial-transactions to predict a risk-score for each financial-transaction. Each predicted risk-score and related financial-transaction may be sent to a bias-tool to receive a level-of-bias for the risk-score. When the received level-of-bias is below a predefined-threshold, deploying the trained fraud-detection ML model in a finance-system in production-environment, otherwise training the fraud-detection ML model on a different generated representative-training-sample-dataset.

### TECHNICAL FIELD

The present disclosure relates to the field of ethical Artificial Intelligence (AI) Machine Learning (ML) algorithms, sampling, and representative training dataset for fraud-prediction ML models.

### BACKGROUND

In general, it is desirable that people would be evaluated based on their behavior instead of demographic parameters, such as geolocation, gender, race, age and the like. In the context of AI, Machine Learning (ML) models may be vulnerable to bias and may provide biased predictions which do not reflect ethics and values in them. Biased predictions may arise, for example, when ML models which are running in a fraud-prevention system in a Financial Institution (FI), flag several times more or decline legitimate transactions from cardholders from poorer or minority neighborhoods than cardholders from wealthier, hegemonic communities.

Accordingly, Artificial Intelligence (AI) bias can influence FI operations, public perceptions, and their customers' lives. These discriminated customers might need to call the contact center of the FI at a higher rate than customers of wealthier, hegemonic communities and may hold grudge against the FIs that commit to tackling AI bias and building more ethical systems stand to secure loyal customers, emerge as industry leaders, avoid penalties from regulators and the Public Relations issues that a public bias scandal could cause.

While human bias is a thorny issue which may not be easily defined, biased predictions of ML models is mathematical, and as such may be controlled. For example, biased predictions of ML models may be controlled by proper representation of different groups or label thereof in training datasets during the ML models learning stage.

An increasing utilization of ML models-based decision support systems emphasizes the need for fraud predictions ML model to be both accurate and fair to all stakeholders. If the results of the ML model are generated by biased, compromised, or skewed datasets e.g., uneven spread, affected parties may not adequately be protected from a discriminatory harm.

Accordingly, there is a need for a technical solution to minimize bias in classification/regression predictions in fraud-detection ML models. Furthermore, there is a need for a method for maintaining ethical Artificial Intelligence (AI) by generating a representative training-sample-dataset for a fraud-detection ML model, thus building an ML model which provides more accurate predictions, i.e., non-biased predictions as to fraud.

### SUMMARY

There is thus provided, in accordance with some embodiments of the present disclosure, a computerized-method for maintaining ethical Artificial Intelligence (AI) by generating a representative training-sample-dataset for training a fraud-detection Machine Learning (ML) model.

In accordance with some embodiments of the present disclosure, in a computerized system including a processor and a memory, operating by the processor a representative-dataset-preparation module to train the fraud-detection Machine Learning (ML) model such that biased predictions may be minimized.

Furthermore, in accordance with some embodiments of the present disclosure, the representative-dataset-preparation module may include: a. receiving financial-transactions related to a business activity during a preconfigured period. Data of each financial transaction of the financial-transactions may include masked sensitive Personal Identifiable Information (PII) parameters, and one or more non-sensitive PII parameters and transaction-related-details; b. aggregating the received financial-transactions based on the one or more non-sensitive PII parameters; c. operating descriptive analytics on the one or more aggregated non-sensitive PII parameters to determine a distribution of each parameter of the one or more aggregated non-sensitive PII parameters and one or more other parameters and storing the determined distribution of each parameter in a data-pool: and d. generating a representative training-sample-dataset by operating balanced sampling on randomly selected preconfigured number of financial-transactions.

Furthermore, in accordance with some embodiments of the present disclosure, the balanced sampling may be operated by applying a configurable-rule on at least two values of a parameter of the one or more aggregated non-sensitive PII parameters of each financial-transaction by the low-frequency value, based on the determined distribution retrieved from the data-pool.

Furthermore, in accordance with some embodiments of the present disclosure, training the fraud-detection ML model on the representative training-sample-dataset.

Furthermore, in accordance with some embodiments of the present disclosure, deploying the trained fraud-detection ML model in a finance-system in test-environment, and operating the trained fraud-detection ML model on a stream of financial transactions to predict a risk score for each financial transaction. Each predicted risk score and related financial transaction may be sent to a bias-tool to receive a level-of-bias for the risk score.

Furthermore, in accordance with some embodiments of the present disclosure, when the received level-of-bias may be above a predefined threshold, repeating operations (i)d. through (iii), and when the received level-of-bias may be below the predefined threshold, deploying the trained fraud-detection ML model in a finance-system that is running in production-environment.

Furthermore, in accordance with some embodiments of the present disclosure, a value of the at least two values of the parameter may be a range of values or a single value. For example, for age parameter a range of ages 18-23 or female and male for gender parameter.

Furthermore, in accordance with some embodiments of the present disclosure, the balanced sampling is minimizing biased predictions of the trained fraud-detection ML model.

Furthermore, in accordance with some embodiments of the present disclosure, when the predicted risk score may be above a preconfigured threshold, in production-environment, a processing of a financial transaction is paused, and the financial-transaction is sent to an inspection-application for analysis.

Furthermore, in accordance with some embodiments of the present disclosure, the operating of the balanced sampling may be further performed by (i) applying the configurable-rule on the randomly selected financial-transactions to take-out a sample of financial-transactions based on the preconfigured-rule; and (ii) repeating operation (i) on remaining financial-transactions until there are no financial-transactions with the value of low-frequency value of the parameter in the remaining randomly selected financial-transactions.

Furthermore, in accordance with some embodiments of the present disclosure, the representative training-sample-dataset may be a combination of at least two representative training-sample-datasets, each training sample dataset has been aggregated based on the configurable rule applied on a different parameter of the non-sensitive PII.

Furthermore, in accordance with some embodiments of the present disclosure, the low-frequency value of the parameter in the financial-transactions is determined by counting a number of financial transactions in the received financial-transactions of each value of the parameter, based on the distribution of each parameter and a value that is in lowest number of financial transactions is the low-frequency value of the parameter.

Furthermore, in accordance with some embodiments of the present disclosure, biased predictions are predictions of the fraud-detection ML model which are different than a value that is determined that the fraud-detection ML has to predict.

Furthermore, in accordance with some embodiments of the present disclosure, fraud-detection ML model may be based on XGBoost algorithm.

Furthermore, in accordance with some embodiments of the present disclosure, the configurable-rule may be a preconfigured ratio λ of a financial-transaction having the low-frequency value parameter and a financial-transaction having rest of values of the parameter.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1 schematically illustrates a computerized-system for maintaining ethical Artificial Intelligence (AI) by generating a representative training-sample-dataset for a fraud-detection Machine Learning (ML) model, in accordance with some embodiments of the present disclosure;

FIGS. 2A-2B are a high-level workflow of a representative-dataset-preparation module, in accordance with some embodiments of the present disclosure;

FIGS. 3A-3B schematically illustrate dataset according to gender, in accordance with some embodiments of the present disclosure;

FIG. 4A shows an example of transactional fragment without PII details, in accordance with some embodiments of the present disclosure;

FIG. 4B shows an example of four financial transactions between eight parties, in accordance with some embodiments of the present disclosure:

FIG. 4C shows an example of aggregative statistics per payor gender, in accordance with some embodiments of the present disclosure:

FIG. 4D is an illustration of configurable balanced sampling, in accordance with some embodiments of the present disclosure;

FIG. 5 is an illustration of maintaining ethical Artificial Intelligence (AI) by generating a representative training-sample-dataset for a fraud-detection Machine Learning (ML) model, in accordance with some embodiments of the present disclosure;

FIG. 6 is a graph showing a comparison in performance of Machine Learning (ML) model (XGBoost) with or without bias in the training dataset, in accordance with some embodiments of the present disclosure;

FIG. 7 is a high-level process flow diagram, in accordance with some embodiments of the present disclosure; and

FIG. 8 is a fraud-detection ML model input/output, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example. “processing,” “computing.” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

The number of cashless transactions is at its peak point since the beginning of the digital era and it is most likely to increase in the future. While it is an advantage and provides ease of use for customers, it also creates opportunities for fraudsters. Fraud detection is in fact a binary classification or regression problem, where the outcome is either false or true or some regression risk score from 0 to 1 that. That classification/regression problem can be solved using supervised machine learning paradigm. A supervised ML approach utilizes past, known financial transactions that are labeled as fraudulent or legitimate. The past data is trained, and the created ML model may be used to predict whether a new financial transaction is fraud or not.

In supervised Machine Learning (ML) a model is trained on labeled, i.e., tagged or annotated data and make predictions in terms of dichotomous labels, e.g., fraud, non-fraud, or in terms of a risk score between 0 and 1 that represent the probability of a financial transaction to be fraudulent or not. Data labeling is performed by human-in-the-loop prior data processing, which is one of the starting stages of a machine learning development flow. The invention includes additional stages to the standard machine learning workflow.

According to some embodiments of the current disclosure, these stages include segmentation, clustering and customer balancing sampling to ensure that the training data for the model is well representative with minimum bias. A predictive model such as Extreme Gradient Boosting (XGBoost) may be operated.

According to some embodiments of the current disclosure, the XGBoost may provide parallel tree boosting and is the leading ML decision tree model for regression, classification, and ranking problems. Non-sensitive Personal Identifiable Information (PII) data may be a prime criterion for segmenting and clustering and it may be used later on for configurable balancing sampling to alleviate data bias in training dataset.

According to some embodiments of the current disclosure, the approach to supervised fraud detection may be through XGBoost classifier/regressor decision tree model. The XGBoost is a widespread and efficient open-source implementation of the gradient boosted trees algorithm. It attempts to accurately predict a target variable by combining the estimates of a set of simpler, weaker models. The XGBoost may be trained on prior labeled data, and then tested on unseen data. i.e., new financial transactions. Once the performance of the ML model is according to predetermined criteria in test environment, the model may be deployed into production environment and runs on client's data, providing prediction per each financial transaction.

One of the major obstacles to provide fairness and robustness in ML solutions is to eliminate the bias that may possibly be present in the data. One of the most common and all-embracing bias is non-representative sample dataset. When the ML model is being trained on non-representative sample dataset, that does not reflect the entire population that is related to a business activity, then the ML model may become biased towards those scenarios which it had been trained on.

For example, when the majority of financial transactions, that the ML model that has been trained on, were performed by customers who live on a certain area, with the same profession and approximately the same level of income, then this ML model may provide predictions which are biased towards other population.

According to some embodiments of the current disclosure, activities are a way to logically group together events that occur in the FI systems. Each channel may be an activity, for example, Web activity. Each type of service may be an activity, for example, Internal Transfer activity. Each combination of an activity and a type of service may be an activity, for example, Web Internal Transfer Activity. Activities may span multiple channels and services, for example, the Transfer activity, which is any activity that results in a transfer. Transactions may be associated with multiple activities.

According to some embodiments of the current disclosure, activities may be divided into multiple base activities. Base activities represent the most specific activity the customer performed and determine which detection models type are calculated for a transaction. Each transaction is mapped to one and only one base activity. The solution calculates a base activity for each transaction. This default base activity is usually determined according to the channel and the transaction type, as well as additional fields and calculations.

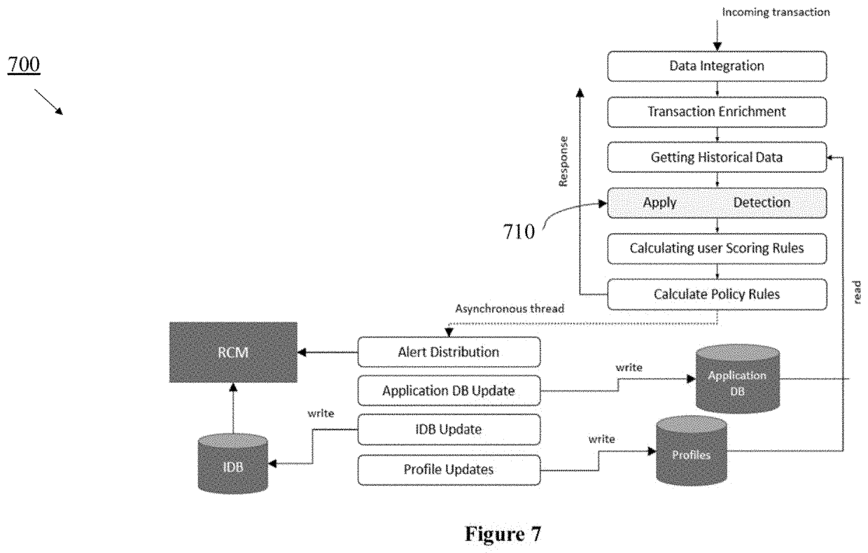

According to some embodiments of the current disclosure, the base activity of a transaction is generally set by combining the channel type and the transaction type as mapped in data integration, as in system 700 in FIG. 7. The definition of some base activities is also based on the value of an additional field or a calculated indicator.

According to some embodiments of the current disclosure, to overcome the issue of bias in the training dataset, a fair sampling from the entire data source has to be ensured, as well as verifying that the training dataset has equal spread of all relevant categories existing in the data, such as geolocation, gender, age etc.

Another issues that has to be addressed is having access to the Personal Identifiable Information (PII) of the customers in the sample dataset due to the principles of data protection and regulatory requirements, Financial Institutions (FIs) must protect namely information of their customers.

According to some embodiments of the current disclosure, when an unrepresentative ML model is created over a biased dataset, the predictions of the ML models which were trained over this dataset may be biased, i.e., not accurate. The accuracy of the predictions of an MIL model may be adjusted, by controlling the provided training dataset, given, that the ML models are based on a statistical segregation over the parameters of a given big data.

According to some embodiments of the current disclosure, data of financial transactions may include non-sensitive Personally Identifiable Information (PII) parameters. PII parameters are easily accessible from public sources and may include details such as zip code, race, gender, date of birth, place of birth, religion and the like. The data may also include sensitive PII which is a combination of sensitive-PII elements, which if disclosed without authorization may be used to inflict substantial harm, to an individual, such as full name, social security number, driver's license, mailing address, credit card information, passport information, financial information, medical records and the like. Non-sensitive PII parameters are non-personal data that does not allow to identify an individual following the General Data Protection Regulation (GDPR) provisions.

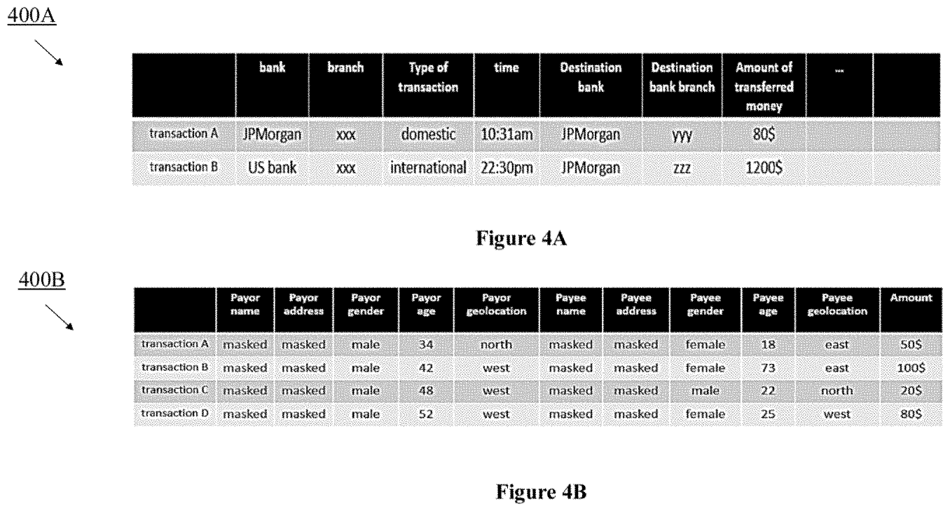

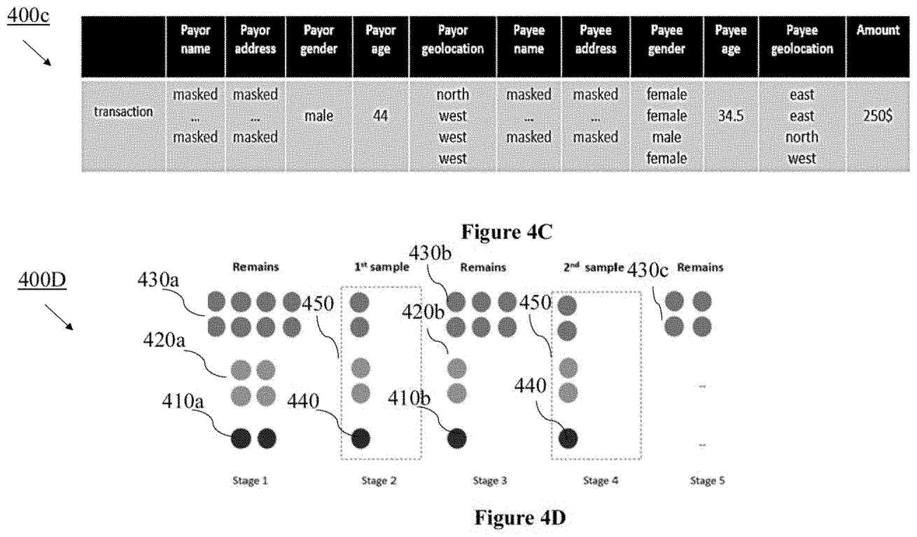

According to some embodiments of the current disclosure, data anonymization seeks to protect private or sensitive data by deleting or encrypting PII parameters from a database. Data anonymization is operated for the purpose of protecting an individual's or company's private activities while maintaining the integrity of the data gathered and shared. Data anonymization is also known as “data obfuscation,” “data masking,” or “data de-identification.”, as shown in example 400A in FIG. 4A. It can be contrasted with de-anonymization, which are techniques used in data mining that attempt to re-identify encrypted or obscured information.

In the financial sector, a customer data must be obscured to meet regulatory requirements. Data anonymization refers to stripping or encrypting personal or identifying information from sensitive data. As businesses, governments, healthcare systems, and other organizations increasingly store individuals' information on local or cloud servers, data anonymization is crucial to maintain data integrity and prevent security breaches.

According to some embodiments of the current disclosure, personal data rendered anonymous in such a manner that the data subject is not or no longer identifiable. Non-sensitive PII may include: generalized data, e.g., age range e.g. 20-40, information gathered by government bodies or municipalities, such as census data or tax receipts collected for publicly funded works, aggregated statistics on the use of a product or service, partially or fully masked IP addresses.

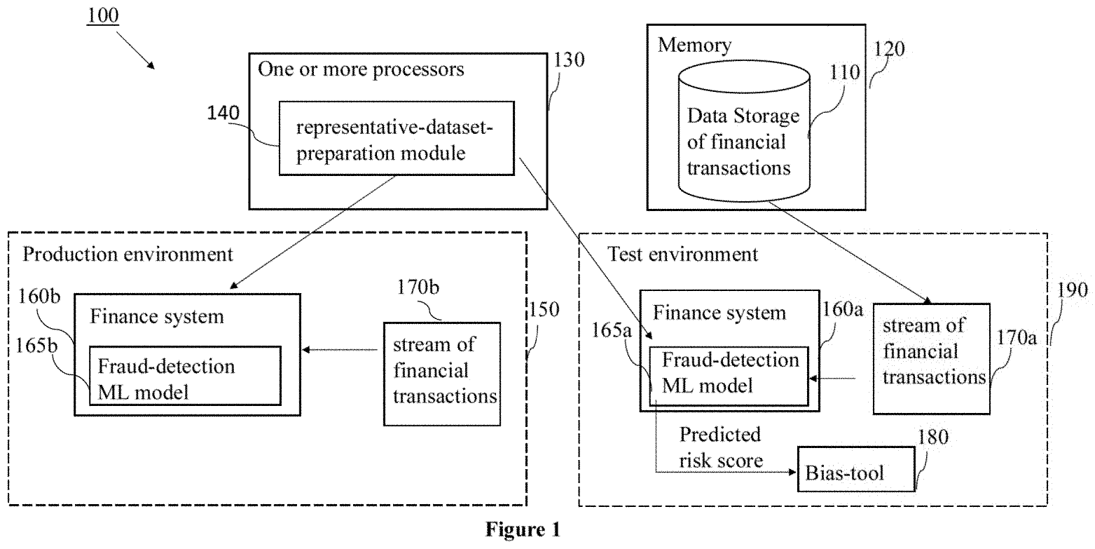

FIG. 1 schematically illustrates a computerized-system 100 for maintaining ethical Artificial Intelligence (AI) by generating a representative training-sample-dataset for a fraud-detection Machine Learning (ML) model, in accordance with some embodiments of the present disclosure.

According to some embodiments of the current disclosure, a computerized-system, such as computerized-system 100 may include a memory 120 to store a data storage of financial transactions 110. The data storage of financial transactions 110 may include financial transactions of a business activity during a preconfigured period. The business activity may be for example, mobile P2P, web internal transfer and the like.

According to some embodiments of the current disclosure, computerized-system 100 may provide a data-driven technology to handle data bias and model fairness and to achieve accuracy and efficacy of fraud predictions by building ML models that infer from datasets that record complex social and historical patterns, which themselves may contain culturally crystallized forms of bias and discrimination. Computerized-system 100 provides a technical solution to the problem of fairness and bias mitigation in architecting ML algorithms.

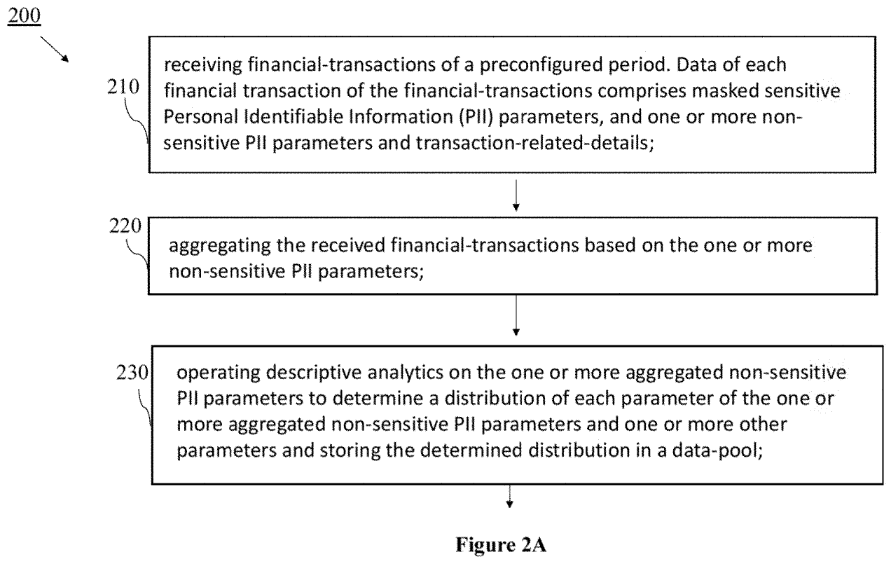

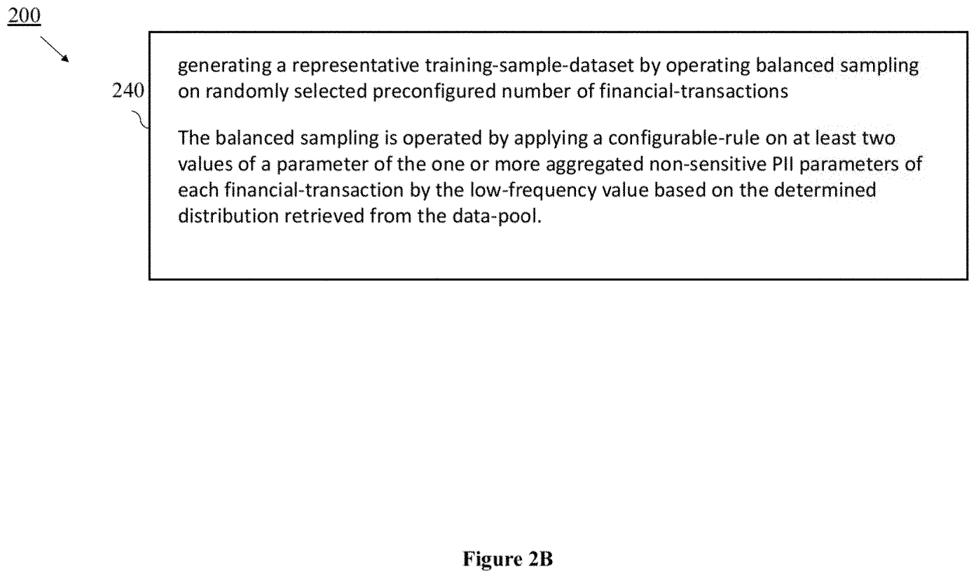

According to some embodiments of the current disclosure, one or more processors, such as one or more processors 130 may operate a module, such as representative-dataset-preparation module 140 and such as representative-dataset-preparation module 200 in FIGS. 2A-2B.

According to some embodiments of the current disclosure, the module, such as representative-dataset-preparation module 140 and such as representative-dataset-preparation module 200 in FIGS. 2A-2B may be operated by the one or more processors 130 to generate a representative training-sample-dataset for a fraud-detection Machine Learning (ML) model. The fraud-detection ML model 165a may be deployed in a finance system 160a in test environment 190 and may be operated on a stream of financial transactions 170a to predict a risk score for each financial transaction.

According to some embodiments of the current disclosure, each predicted risk score may be sent to a bias-tool 180. When the received level-of-bias may be below a predefined threshold, the trained fraud-detection ML model 165b may be deployed in a finance-system 160b in production-environment 150 to receive a stream of financial transactions 170b and predict a risk score per each.

According to some embodiments of the current disclosure, the received level-of-bias may be checked against a predefined threshold for a preconfigured number of financial transactions. The value of the level-of-bias of the preconfigured number of financial transactions for the comparison may be an average of all the level-of-bias or any other statistics according to a decision of the fraud-detection ML model governance or a Subject Matter Expert (SME).

According to some embodiments of the current disclosure, when the received level-of-bias from the bias-tool 180 may be above a predefined threshold, generating a representative training-sample-dataset by operating balanced sampling on randomly selected preconfigured number of financial-transactions and then training the fraud-detection ML model on the generated representative training-sample-dataset and deploying it in the finance system 160a in the test environment 190. The balanced sampling may minimize biased predictions of the trained fraud-detection ML model.

According to some embodiments of the current disclosure, the balanced sampling may be operated by applying a configurable-rule on at least two values of a parameter of the one or more aggregated non-sensitive PII parameters of each financial-transaction by low-frequency value based on the determined distribution retrieved from the data-pool, as shown in FIG. 4D when λ=2, to alleviate unfair spread in the training dataset and to ensure fairness in fraud detection.

According to some embodiments of the current disclosure, the non-sensitive PII parameters may be aggregated such that the data is anonymous to meet regulatory requirements, as shown in example 400A, in FIG. 4A. The low-frequency value of the parameter in the financial-transactions may be determined by counting a number of financial transactions in the received financial-transactions of each value of the parameter, based on the distribution of each parameter and a value that is in lowest number of financial transactions is the low-frequency value of the parameter.

According to some embodiments of the current disclosure, the configurable-rule may be a preconfigured ratio λ of a financial-transaction having the low-frequency value parameter and a financial-transaction having rest of values of the parameter.

According to some embodiments of the current disclosure, a value of the at least two values of the parameter is a range of values or a single value. For example, a gender or a range of ages.

According to some embodiments of the current disclosure, the operating of the balanced sampling may be further performed by (i) applying the configurable-rule on the randomly selected financial-transactions to take-out a sample of financial-transactions based on the preconfigured-rule: and (ii) repeating operation (i) on remaining financial-transactions until there are no financial-transactions with the value of the low-frequency value of the parameter in the remaining financial transactions.

According to some embodiments of the current disclosure, when the predicted risk score of a financial transaction may be above a preconfigured threshold, in production-environment 150, a processing of a financial transaction may be paused, and the financial-transaction may be sent to an inspection-application for analysis.

According to some embodiments of the current disclosure, the generated representative training-sample-dataset may be a combination of at least two training-sample-datasets, each training-sample-dataset has been aggregated based on the configurable mile based on a different parameter of the non-sensitive PII.

According to some embodiments of the current disclosure, biased predictions may be predictions of the fraud-detection ML model which are different than a value that is determined that the fraud-detection ML has to predict.

According to some embodiments of the current disclosure, the fraud-detection ML model may be based on XGBoost algorithm.

According to some embodiments of the current disclosure, the applied aggregating technique may improve the accuracy of the combined fraud detection ML models because the generated dataset becomes more representative by incorporating aggregation of non-sensitive PII data and controlling the sampling parameters of non-representative data.

According to some embodiments of the current disclosure, the module, such as representative-dataset-preparation module and such as representative-dataset-preparation module 200 in FIGS. 2A-2B may be configured to: a. receive financial-transactions of a preconfigured period, wherein data of each financial transaction of the financial-transactions comprises masked sensitive Personal Identifiable Information (PII) parameters, and one or more non-sensitive PII parameters and transaction-related-details; b. aggregate the received financial-transactions based on the one or more non-sensitive PII parameters: c. operate descriptive analytics on the one or more aggregated non-sensitive PII parameters to determine a distribution of each parameter of the one or more aggregated non-sensitive PII parameters and one or more other parameters and storing the determined distribution in a data-pool; and d. generate a representative training-sample-dataset by operating balanced sampling on randomly selected preconfigured number of financial-transactions.

According to some embodiments of the current disclosure, the balanced sampling is operated by applying a configurable-rule on at least two values of a parameter of the one or more aggregated non-sensitive PII parameters of each financial-transaction by the low-frequency value based on the determined distribution retrieved from the data-pool.

FIGS. 2A-2B are a high-level workflow of a representative-dataset-preparation module 200, in accordance with some embodiments of the present disclosure.

According to some embodiments of the current disclosure, in a computerized-system such as computerized system 100 in FIG. 1, having a data storage of financial transactions, such as data storage 110 in FIG. 1, operating by the one or more processors 130 in FIG. 1 a module, such as representative-dataset-preparation module 140 and such as representative-dataset-preparation module 200.

According to some embodiments of the current disclosure, operation 210 may comprise receiving financial-transactions of a preconfigured period. Data of each financial transaction of the financial-transactions comprises masked sensitive Personal Identifiable Information (PII) parameters, and one or more non-sensitive PII parameters and transaction-related-details.

According to some embodiments of the current disclosure, operation 220 may comprise aggregating the received financial-transactions based on the one or more non-sensitive PII parameters.

According to some embodiments of the current disclosure, operation 230 may comprise operating descriptive analytics on the one or more aggregated non-sensitive PII parameters to determine a distribution of each parameter of the one or more aggregated non-sensitive PII parameters and one or more other parameters and storing the determined distribution in a data-pool.

According to some embodiments of the current disclosure, descriptive analytics may be for example, ratio between man and women between 22-34 years old living in the north of the country, ratio between women between 35-45 living in the west, average amount of money withdraw in man in ages 18-22 living in the east, total amount of money withdrawal between 2022 Oct. 3 and 2022 Oct. 5 between 10 pm-11 pm among elderly people from the north that are white (race), standard deviation for money among men and women between 45-55 years old from north to west and the like.

According to some embodiments of the current disclosure, a descriptive analytics component stores the data and its descriptive statistics insights. Descriptive analytics describes the use of a range of historic data such that comparisons may be drawn. Most commonly reported financial metrics are a product of descriptive analytics, for example, year-over-year pricing changes, month-over-month sales growth, the number of users, or the total revenue per customer. These measures describe what has occurred in a financial institution during a preconfigured period.

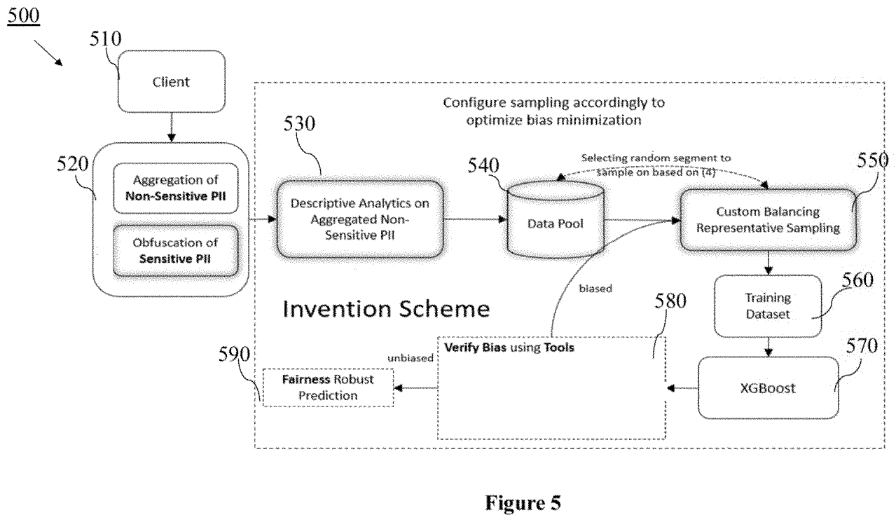

According to some embodiments of the current disclosure, operation 240 may comprise generating a representative training-sample-dataset by operating balanced sampling on randomly selected preconfigured number of financial-transactions. The balanced sampling may be operated by applying a configurable-rule on at least two values of a parameter of the one or more aggregated non-sensitive PII parameters of each financial-transaction by the low-frequency value based on the determined distribution retrieved from the data-pool, as described in detail in FIG. 5.

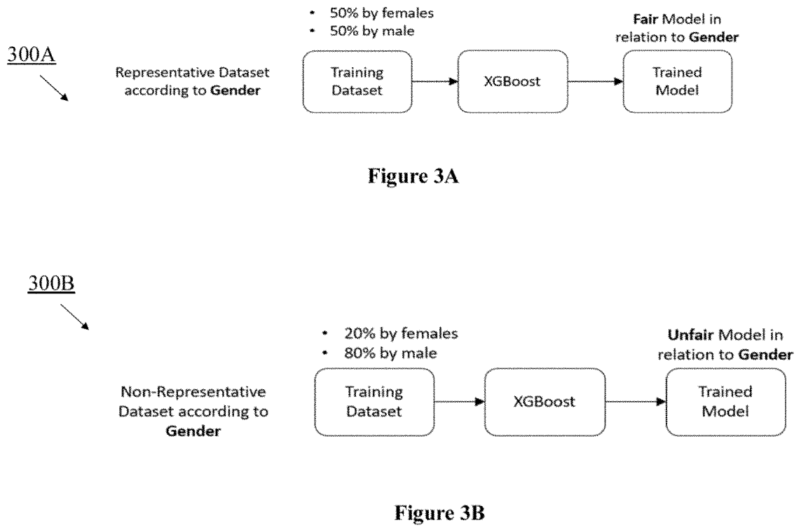

FIGS. 3A-3B schematically illustrate datasets 300A and 300B according to gender, in accordance with some embodiments of the present disclosure.

According to some embodiments of the current disclosure, configurable balancing sampling may be a process that regulates data sampling according to certain categories of its data or meta-data. For example, each financial transaction contains information about a financial operation, the gender of the individual who made the transaction, its location, device or branch and the like. Based on this information the financial transactions are selected into a training dataset for an ML model in a process that may be fully automated, semi-automated or manually performed.

According to some embodiments of the current disclosure, FIGS. 3A-3B illustrate a scenario where there is biased data 300B or non-biased data 300A only according to one category e.g., gender. However, in practice a representative training dataset has to meet the balance on its multi-sides, e.g., several categories, which may present a technical challenge because it requires performance of multivariate analysis of the bias measured by relational categories which can bring to partial differential equations.

According to some embodiments of the current disclosure, FIG. 3A illustrates an example of balanced training dataset by gender and fair trained ML model in relation to gender.

According to some embodiments of the current disclosure, FIG. 3B illustrates an example of skewed training dataset by gender and unfair trained model in relation to gender.

FIG. 4B shows an example 400B of four financial transactions between eight parties, in accordance with some embodiments of the present disclosure.

According to some embodiments of the current disclosure, in example 400B, four financial transactions in which four people, i.e., payors, sent their money to other four people, i.e., payees. Sensitive-PII, such as names were masked or obfuscated. Non-sensitive PII, such as gender, age and geolocation may be aggregated by a module, such as representative-dataset-preparation module 140 in FIG. 1 and representative-dataset-preparation module 200 in FIGS. 2A-2B.

FIG. 4C shows an example 400C of aggregative statistics per payor gender, in accordance with some embodiments of the present disclosure.

According to some embodiments of the current disclosure, when representative-dataset-preparation module 140 in FIG. 1 may aggregate the received financial-transactions based on one or more non-sensitive PII parameters. For example, when the non-sensitive PII parameter is payor gender, example 400C shows four transactions on total sum of 250$ (or 62.5$ in average) which were conducted. 44 years old is an average age of payor male. 34.5 years old is an average age of payee. On the payee side, there are 3 females and 1 male. 2 people live in east, 1 in north and 1 in west.

According to some embodiments of the current disclosure, the aggregated data of financial-transactions based on payor gender in example 400C shows valuable and informative insights on one side, but on the other side customers privacy is fully preserved by the aggregative operation and any sensitive information about the customers may not be inferred or concluded.

According to some embodiments of the current disclosure, the aggregation may be operated on another non-sensitive PII parameter, such as payee gender or payor geolocation or any other parameter. A combination of these aggregations of one or more non-sensitive PII parameters, may derive a dataset which may be stored in a data pool, such as data pool 540 in FIG. 5, from which balance sampling may be operated based on a configurable-rule on randomly selected preconfigured number of financial-transactions from the dataset. Thus, the generated representative training-sample-dataset itself may preserve a balance in preselected non-sensitive PII categories, such as age, gender, race, geolocation and the like.

FIG. 4D is an illustration of configurable balanced sampling 400D, in accordance with some embodiments of the present disclosure.

According to some embodiments of the current disclosure, in balanced sampling, data may be selected from a dataset e.g., aggregated financial-transactions based on one or more non-sensitive PII parameters, as shown for example of aggregative statistics, for one parameter such as per payor gender, in example 400C in FIG. 4C, by providing priority to minority. The minority may be a low-frequency value based on the determined distribution that may be retrieved from a data-pool.

According to some embodiments of the current disclosure, for example, the minority may be represented by balls 410a-c. At the first stage there are two balls 410a, four balls 420a and eight balls 430a. The balanced sampling may be operated according to category 410a based on a configurable rule, such as determining a ratio parameter for this minority. For example, for each ball from balls 410a, there will be selected other balls, when λ may be the ratio parameter, e.g., λ=2, then, per each ball of 410a, there will be selected 1*λ other balls.

According to some embodiments of the current disclosure, in the first sampling from the dataset, one ball 440 may be selected from 410a and four balls 450 which are two from 420a and two from 430a. In the remaining dataset there may be one ball 410b, two balls 420b and six balls 430b.

According to some embodiments of the current disclosure, in the second sampling from the remaining dataset, one ball 440 may be selected from 410a and four balls 450 which are two from 420a and two from 430a. In the remaining dataset there may be four balls 430c. Since there are no balls which represent the minority the balanced sampling stops.

According to some embodiments of the current disclosure, a user may decide how the training dataset, such as training dataset 560 in FIG. 5, should look like and decide accordingly how to configure its balanced sampling mechanism, e.g. custom balancing representative balancing in FIG. 5.

FIG. 5 is an illustration of a computerized-method 500 for maintaining ethical Artificial Intelligence (A) by generating a representative training-sample-dataset for a fraud-detection Machine Learning (ML) model, in accordance with some embodiments of the present disclosure.

According to some embodiments of the current disclosure, an FI, e.g., client 510 may provide financial-transactions of a preconfigured period. Data of each financial transaction of the financial-transactions comprises masked sensitive Personal Identifiable Information (PII) parameters, and one or more non-sensitive PII parameters and transaction-related-details.

According to some embodiments of the current disclosure, the data may be provided such that all sensitive PIs went through obfuscation process by the client 510. Then, a module, such as representative-dataset-preparation module 140 in FIG. 1, may aggregate the received financial-transactions based on the one or more non-sensitive PII parameters 520 to preserve some level of anonymity which is enough for Non-sensitive PII.

According to some embodiments of the current disclosure, all the non-sensitive data may be aggregated and preserve the metadata, such as gender, age, geolocation etc. The aggregation enables to catalog the aggregated data and to perform on it descriptive analytics by a descriptive analytics component 530. The descriptive analytics may be for example, ratio between man and women between 22-34 years old living in the north of the country, ratio between women between 35-45 living in the west, average amount of money withdraw in man in ages 18-22 living in the east, total amount of money withdrawal between 2022 Oct. 3 and 2022 Oct. 5 between 10 pm-11 pm among elderly people from the north that are white (race), and standard deviation for money among men and women between 45-55 years old from north to west.

According to some embodiments of the current disclosure, the descriptive analytics component 530 may store the data and its descriptive statistics insights in a data pool, such as data pool 540. Descriptive analytics describes the use of a range of historic data to draw comparisons. Most commonly reported financial metrics are a product of descriptive analytics, for example, year-over-year pricing changes, month-over-month sales growth, the number of users, or the total revenue per customer.

According to some embodiments of the current disclosure, a module, such as representative-dataset-preparation module 140 in FIG. 1 may generate a representative training-sample-dataset by operating balanced sampling on randomly selected preconfigured number of financial-transactions from the data pool 540. During the operation of balanced sampling, module representative-dataset-preparation module 140 in FIG. 1 may identify primer categories based on which it may configure the balanced sampling out of.

According to some embodiments of the current disclosure, representative-dataset-preparation module 140 in FIG. 1 may randomly select a data segment e.g., preconfigured number of financial-transactions from the data pool 540 and may perform balanced sampling on it.

According to some embodiments of the current disclosure, after the representative-dataset-preparation module 140 in FIG. 1 may train the fraud-detection ML model on the generated representative training-sample-dataset 560, and the trained fraud-detection ML model. e.g., XGBoost 570 may be deployed in test environment to provide a risk score for a stream of financial transactions.

According to some embodiments of the current disclosure, each predicted risk score of the fraud-detection ML model and related financial transaction may be sent to a bias-tool, such as bias tool 180 in FIG. 1 and such as tools 580 to receive a level-of-bias for the predicted risk score. An amount of bias within predictions may be verified by a bias-tool 580. When the received level-of-bias is above a predefined threshold, then the representative-dataset-preparation module 140 in FIG. 1 may repeat the custom balancing representative sampling 550 i.e., select another random segment and resampling again to generate a representative training-sample-dataset on randomly selected preconfigured number of financial-transactions from data pool 540 and then use the generated representative training-sample-dataset to train the fraud-detection ML model and then deploy it in test environment.

According to some embodiments of the current disclosure, for example, the data of the randomly selected segment may have a few financial transactions from certain geolocation and under certain amount of money thus the selected segment may be non representative when the entire population of the business activity comes from a different geolocation, or from another deposit or withdrawal ranges of money. When this is the situation, the client 510 might want to set the parameter of geolocation as a prime category and configure the balanced sampling accordingly.

According to some embodiments of the current disclosure, factors which might impact the quality of the fraudulent dataset: partial data when the provided fraud report is based on one system but the client is using few other systems to monitor fraud data, only alerted transactions were included with no missing fraud that might impact the ability of the tuned model to learn from the current model's weakness, wrong fraud tagging done by the fraud investigators.

According to some embodiments of the current disclosure, the bias tool 580 may be selected from what-if AI Fairness 360, Crowdsourcing, LIME and FairML.

According to some embodiments of the current disclosure, when the received level-of-bias may be below the predefined threshold, the trained fraud-detection ML model may be deployed in a finance-system in production-environment, such as production environment 150 in FIG. 1, thus providing a robust fairness prediction 590.

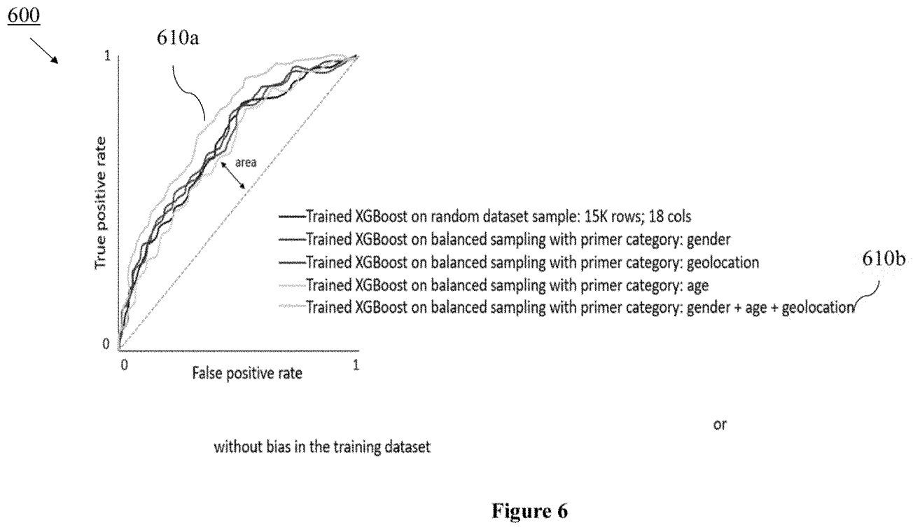

FIG. 6 shows a graph 600 presenting a comparison in performance of Machine Learning (ML) model (XGBoost) with or without bias in the training dataset, in accordance with some embodiments of the present disclosure.

According to some embodiments of the current disclosure, when operating a configurable balanced sampling, such as custom sampling 550 in FIG. 5 and such as operation 240 in FIG. 2B on a combination of three non-sensitive PII aggregated categories, such as gender, age and geolocation, the performance of the fraud-detection ML model 610b extends significantly, as shown in the graph 600 by the area from the dotted line to line 610a.

According to some embodiments of the current disclosure, each category by its own when configured with balanced sampling provides better results than on a random training dataset

FIG. 7 is a high-level process flow diagram 700, in accordance with some embodiments of the present disclosure.

According to some embodiments of the current disclosure, the trained fraud-detection ML model, such as fraud-detection ML model 165b in a finance-system in production-environment, such as production environment 150 in FIG. 1 may be deployed in a detection model such as detection model 710.

According to some embodiments of the current disclosure, system 700 includes incoming transactions into data integration component which is responsible to make an initial preprocess of the data. Transaction enrichments is the process where preprocess of the transactions happen. The process of getting historical data synchronizes with new incoming transactions. It is followed by the fraud detection system 710 after which, each transaction gets its risk score. Policy calculation treats the suspicious scores and routes accordingly. Profiles contain aggregated financial transactions according time period. Profile updates synchronize according to new created or incoming transactions. Customer Relationship Management (RCM) is a system where risk score management is operated: investigation, monitoring, sending alerts, or marking as no risk.

According to some embodiments of the current disclosure, IDB system is used when research transactional data and policy rules resulting for investigation purposes. It analyzes historical cases and alert data. The data may be used by the representative-dataset-preparation module 140 in FIG. 1 or by external applications that can query the database, for example to produce rule performance reports.

According to some embodiments of the current disclosure, analysts can define calculated variables using a comprehensive context, such as the current transaction, the history of the main entity associated with the transaction, the built-in models results etc. These variables can be used to create new indicative features. The variables can be exported to the detection log, stored in IDB and exposed to users in user analytics contexts.

According to some embodiments of the current disclosure, transactions that satisfy certain criteria may indicate occurrence of events that may be interesting for the analyst. The analyst can define events the system identifies and profiles when processing the transaction. This data can be used to create complementary indicative features (using the custom indicative features mechanism or SMO). For example, the analyst can define an event that says: amount>$100,000. The system profiles aggregations for all transactions that trigger this event (e.g. first time it happened for the transaction party etc.).

According to some embodiments of the current disclosure, Structured Model Overlay (SMO) is a framework in which the analyst gets all outputs of built-in and custom analytics as input to be used to enhance the detection results with issues and set the risk score of the transaction.

According to some embodiments of the current disclosure, analytics logic is implemented in two phases, where only a subset of the transactions goes through the second phase, as determined by a filter. The filter may be a business activity.

According to some embodiments of the current disclosure, the detection log contains transactions enriched with analytics data such as indicative features results and variables. The Analyst has the ability to configure which data should be exported to the log and use it for both pre-production and post-production tuning.

According to some embodiments of the current disclosure, the detection flow for transactions consists of multiple steps, data fetch for detection (detection period sets and profile data for the entity), variable calculations, Analytics models consisting of different indicative feature instances, and SMO (structured model overlay).

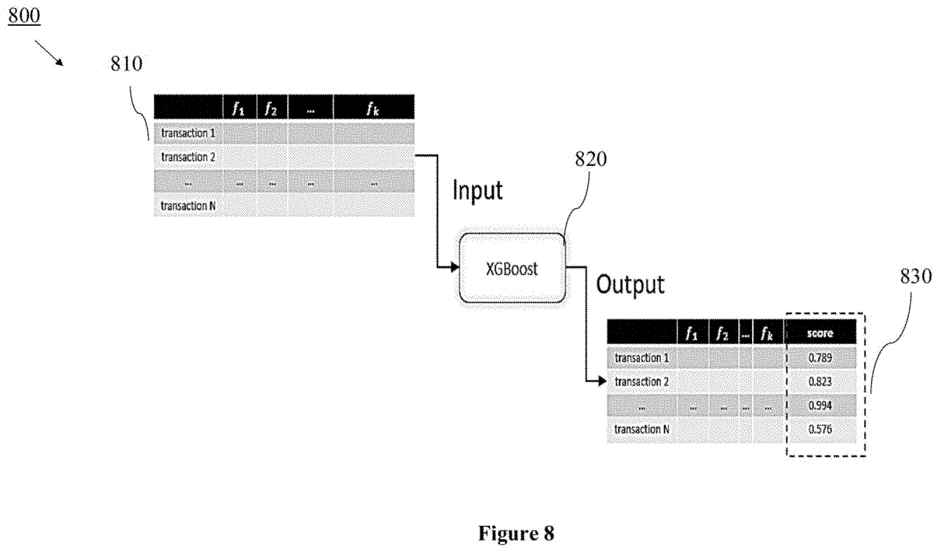

FIG. 8 is a fraud-detection ML model—input/output, in accordance with some embodiments of the present disclosure.

According to some embodiments of the current disclosure, incoming transactions data 810, consisting from rows e.g., transactions and columns e.g., attributes per transaction or features. Each attribute of feature may be personal information, deposit amounts, withdrawal amount, details of branches, banks, devices and other information. The input 810 to the trained fraud-detection ML model, such as XGBoost 820 may aggregated tabular data per business activity. There are different types of base activities which consists of two parts: channel and transaction type. The channel activities may be: Web, Mobile, Phone, Branch, ATM, POS, API. The transaction types may be domestic, international, ACH, P2P, Enrollment and the like.

According to some embodiments of the current disclosure, examples for typical base activities may be Web International Transfer, Mobile Domestic Transfer, ATM International Transfer and the like.

According to some embodiments of the current disclosure, the output 830 of the trained fraud-detection ML model, such as XGBoost 820 may have the same structure as the input 810 with one augmented column on the right. This column indicates a risk score provided by the trained fraud-detection ML model. The value of this regression risk score indicates how probable is that the given transaction is fraud. The higher the score, the more probability that this is fraud. Characteristics of the data: Tabular financial data; dimensions—15K rows and 18 cols.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for maintaining ethical Artificial Intelligence (AI) by generating a representative training-sample-dataset for a fraud-detection Machine Learning (ML) model, said computerized-method comprising:
in a computerized-system comprising one or more processors and a memory,
(i) operating by the one or more processors a representative-dataset-preparation module, said representative-dataset-preparation module comprising:
a. receiving financial-transactions related to a business activity during a preconfigured period, wherein data of each financial transaction of the financial-transactions comprises masked sensitive Personal Identifiable Information (PII) parameters, and one or more non-sensitive PII parameters and transaction-related-details;
b. aggregating the received financial-transactions based on the one or more non-sensitive PII parameters;
c. operating descriptive analytics on the one or more aggregated non-sensitive PII parameters to determine a distribution of each parameter of the one or more aggregated non-sensitive PII parameters and one or more other parameters and storing the determined distribution in a data-pool; and
d. generating a representative training-sample-dataset by operating balanced sampling on randomly selected preconfigured number of financial-transactions,
wherein the balanced sampling is operated by applying a configurable-rule on at least two values of a parameter of the one or more aggregated non-sensitive PII parameters of each financial-transaction by a low-frequency value based on the determined distribution retrieved from the data-pool:
(ii) training the fraud-detection ML model on the representative training-sample-dataset; and
(iii) deploying the trained fraud-detection ML model in a finance-system in test-environment, and operating the trained fraud-detection ML model on a stream of financial transactions to predict a risk score for each financial transaction,
wherein each predicted risk score and related financial transaction are sent to a bias-tool to receive a level-of-bias for the risk score,
wherein when the received level-of-bias is above a predefined threshold, repeating operations (i)d. through (iii), and
wherein when the received level-of-bias is below the predefined threshold, deploying the trained fraud-detection ML model in a finance-system in production-environment.

2. The computerized-method of claim 1, wherein a value of the at least two values of the parameter is a range of values or a single value.

3. The computerized-method of claim 1, wherein the balanced sampling is minimizing biased predictions of the trained fraud-detection ML model.

4. The computerized-method of claim 1, wherein when the predicted risk score is above a preconfigured threshold, in production-environment, a processing of a financial transaction is paused, and the financial-transaction is sent to an inspection-application for analysis.

5. The computerized-method of claim 1, wherein the operating of the balanced sampling is further by (i) applying the configurable-rule on the randomly selected financial-transactions to take-out a sample of financial-transactions based on the preconfigured-rule: and (ii) repeating operation (i) on remaining financial-transactions until there are no financial-transactions with the value of the low-frequency value of the parameter.

6. The computerized-method of claim 1, wherein the generated representative training-sample-dataset is a combination of at least two representative training-sample-datasets, each training sample dataset has been aggregated based on the configurable rule based on a different parameter of the non-sensitive PII.

7. The computerized-method of claim 1, wherein the low-frequency value of the parameter in the financial-transactions is determined by counting a number of financial transactions in the received financial-transactions of each value of the parameter, based on the distribution of each parameter and a value that is in lowest number of financial transactions is the low-frequency value of the parameter.

8. The computerized-method of claim 1, wherein biased predictions are predictions of the fraud-detection ML model which are different than a value that is determined that the fraud-detection ML has to predict.

9. The computerized-method of claim 1, wherein the fraud-detection ML model is based on XGBoost algorithm.

10. The computerized-method of claim 1, wherein the configurable-rule is a preconfigured ratio λ of a financial-transaction having the low-frequency value parameter and a financial-transaction having rest of values of the parameter.
